(19) United States
(12) Patent Application Publication
(10) Pub. No.: US 2011/0157488 A1
(43) Pub. Date: Jun. 30, 2011

(54) METHOD AND APPARATUS OF PROJECTOR COLOR ENHANCEMENT BY DYNAMIC LAMP WAVEFORM

(75) Inventors: Chen-Kang Su, Taipei County (TW); Hsin-Yu Chen, Taipei County (TW)

(73) Assignee: ACER INCORPORATED, Taipei County (TW)

(21) Appl. No.: 12/647,310

(22) Filed: Dec. 24, 2009

(51) Int. Cl. H04N 5/64

(52) U.S. Cl. 348/789; 348/E05.128

(57) ABSTRACT

A projector of enhanced color visual output and the method of enhancing the color vividness of a projector output, wherein the projector has a program of instructions stored within its memory to perform image data analysis. The image data analysis includes RGB level detection and histogram calculation. The projector dynamically compares these data, using a waveform selection algorithm, to dynamically select an appropriate waveform from a waveform data table stored in the memory. As a result, the projector constantly changes to use a driving waveform for the light source that is appropriate for the content of the projected image. By using a dynamic waveform to vary the light source, the brightness of selected color region is enhanced to improve vividness of color on a projected image.

### CROSS-REFERENCE TO RELATED APPLICATIONS

Not Applicable.

### BACKGROUND OF THE INVENTION

(1) Field of the Invention

The field of the invention is projectors.

(2) Description of Related Art Including Information Disclosed Under 37 CFR 1.97 and 1.98

The technology of projecting an image on a surface has improved over the years. It has been the objective of those skilled in the technology to look for ways to enhance the color presentation of a projected image.

There is a continuing need for new ways to provide a more vivid presentation in color images and color video images via a projector.

Generally known methods of enhancing color display performance include that disclosed by Miyazawa, U.S. Patent Application Publication No. US2008/0106703 A1, which is incorporated herein by reference in its entirety. Despite numerous desirable methods, however, there remains room for other ways to enhance color display performance.

Thus, there is still a need for methods and apparatus to enhance color display performance in projected still and video images via a projector on a surface.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

Among the many different possibilities contemplated, the projection system of color visual output may have a housing, a color wheel disposed within said housing, a light source disposed within said housing, a processor disposed within said housing, a memory in communication with said processor, and a program of instructions stored within said memory to perform image data analysis. It is further contemplated that the analysis includes RGB level detection in a plurality of regions of at least a single frame of the inputted image data.

Further, it is contemplated that the program of instructions also performs histogram calculation on least a single frame of the inputted image data.

Contemplated projection system can have a waveform selection algorithm stored within the memory.

In preferred embodiments the projection system has an ADC (analog-to-digital) decoder and a scaler within the housing of the projection system, and the program of instructions directs, or enables, the ADC decoder to perform an image data analysis. Additionally, the program of instructions directs, or enables, the scaler to perform histogram calculation.

The projection system additionally has a waveform data table stored in the memory, containing a selection of waveforms to optimize a color vividness of the visual output. Each waveform in this selection of waveforms alters the light source so that the light source works with the color wheel to focus on a selected color regions/groups.

Another aspect of the invention is directed to methods of enhancing optical color in an visual output of a projection system. In preferred embodiments, the method includes the step of having a projection system with a color wheel and a lamp, inputting an image data, having a logic to perform a dynamic mode, performing content analysis of the image data, and selecting a dynamic waveform. In the preferred embodiments, the visual output being enhanced can be a still image, or video/motion images.

Further, the contemplated method dynamically adjusts, or changes, a waveform of the light source to enhance a color vividness base on a content type and content data of the inputted image. Adjusting a waveform actively controls the output of the light source, before it passes through the color wheel, thereby selectively changing the brightness of certain colors. Again, the content type includes still images and video/motion images.

Contemplated color enhancement method can include the step of performing content analysis including passing a video graphics array (VGA) signal through an analog to digital (ADC) decoder to detect a RGB (red, green, blue) level of at least a single frame of the image data. And in that process, the single frame is analyzed in a detection window, wherein the detection window is divided into a plurality of detection regions by a grid. Preferably, each of said plurality of detection regions is separately analyzed to obtain the RGB level of each detection region. It should be noted that the “detection window” can, but preferably is not a physical window. The contemplated detection window is a concept that a single frame image is to be detected separately in different “blocks,” or regions of the single frame.

Further contemplated method can include the step of calculating a histogram of the image data using a scaler. And, in preferred embodiments, the method further includes the step of selecting a matching waveform index of the image data by comparing a first value derived from content analysis to a second value derived from histogram, and further compare these data to a waveform selection algorithm.

The method preferably includes the step of selecting a corresponding waveform from a waveform data table stored in the memory of a processor to enhance the color vividness of the visual output.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an exploded view of components in a digital light processing projection system.

FIG. 2 illustrates the color wheel of a DLP projector and lamp AC pulse waveform.

FIG. 3 is a flow diagram illustrating the method steps of one embodiment of the present invention.

FIG. 4A illustrates an exemplary embodiment of a detection window divided into nine detection regions by a grid.

FIG. 4B illustrates an exemplary embodiment of a detection window divided into 16 detection regions by a grid.

FIG. 5 is a flow diagram of operation representing one embodiment of present invention.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below. It should also be noted that the drawings are in simplified form and are not to precise scale.

In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

In one preferred aspect of the inventive subject matter, the projection system provides a color visual output, wherein the color vividness and performance of the visual output is enhanced. The contemplated color visual output can include still images and video images.

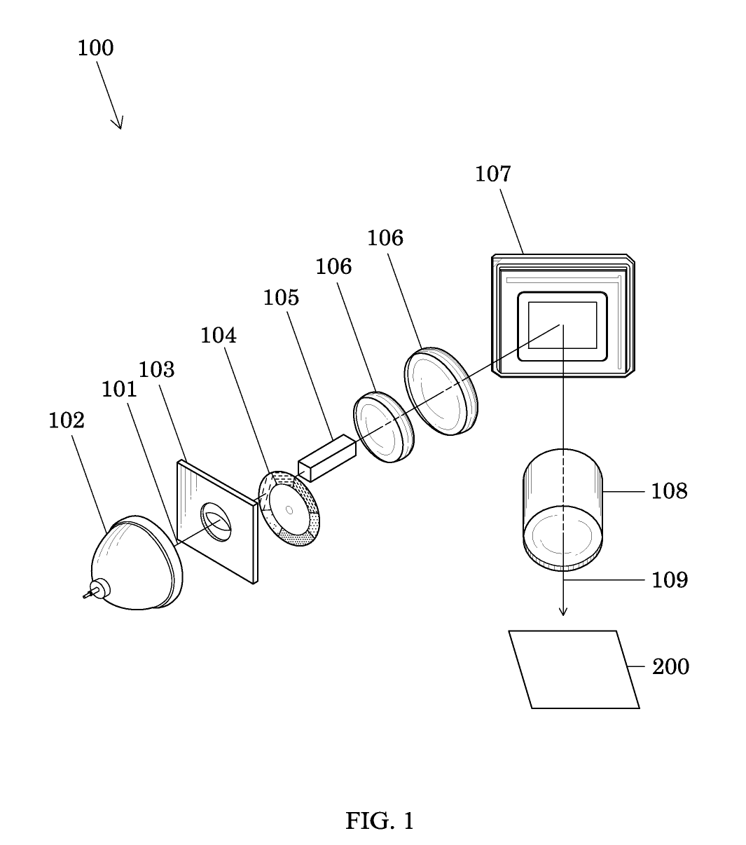

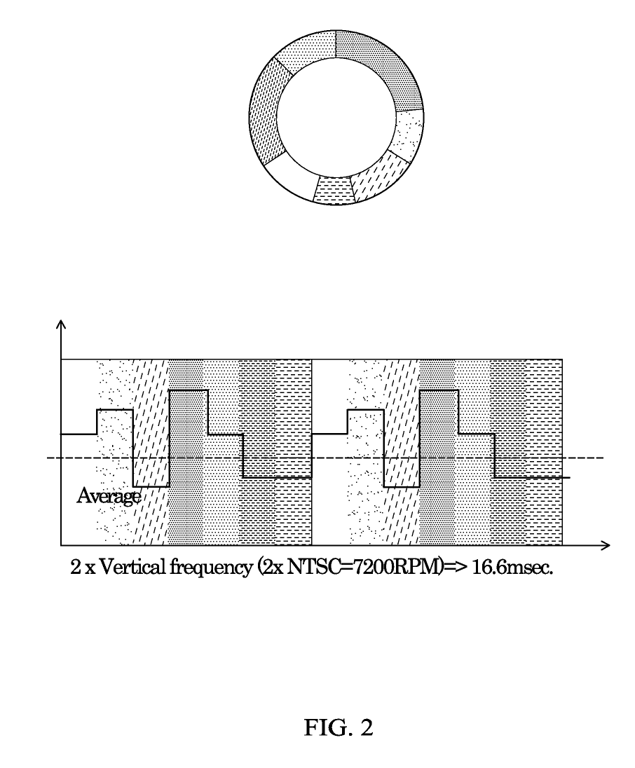

FIG. 1 illustrates a DLP (Digital Light Processing) projector. Colors of the visual output are produced from white light generated by a light source (e.g., lamp 102) passing through an aperture 103, and then a color wheel 104. By rotating the color wheel 104, incoming light 101 is filtered into a plurality of colors, such as three main colors (red, green and blue) and four secondary colors (cyan, magenta, yellow and white). The light 101 also passes through an integrator rod 105, and optics 106. The light, after filtering, is then reflected off the surface of DMD 107 (Digital Micromirror Device) and is passed through a projection lens 108 to project onto a surface (e.g., a screen 200).

An important feature of the present inventive subject matter is the ability to boost optical performance by dynamically controlling the light source 102.

Another important feature of the present inventive subject matter is power management of the system based on inputted image content.

Contemplated projection systems and methods allow a projector 100 to automatically determine the content (e.g., still images or video images) of the inputted image data. And, based on the content of the inputted image data, the projector is capable of controlling color tones to selectively enhance the color in the visual output 109, shown as the projected image. In further contemplated embodiments, based on the content of the inputted image data, and based on the detected values associated with various regions in a frame of the image data, the projector automatically and selectively adjusts the AC voltage waveform of the projector lamp 101 to accommodate the image content. In essence, the projector automatically and dynamically adjusts the brightness of each color block on the color wheel 104 to enhance the color vividness in the visual output.

In some embodiments, the light source 102 can focus energy on different sectors of the color wheel by actively changing AC pulse waveform, as defined by lamp illumination intensity. Also contemplated is adjusting the AC pulse waveform to meet specific needs in the visual output 109. For example, to increase the brightness of white color in the projector output 109, majority of the AC pulse waveform would be focused on the white sector of the color wheel. In another example, to increase color vividness, a majority of the pulse waveform would be focused on the specified color sectors of the color wheel. In other words, the projector actively adjusts a waveform to control the output of the light source passing through the color wheel, thereby selectively changing the brightness of certain colors.

In some further embodiments, the light source 102, or light emitting element, is controlled by a plurality of driving waveforms to dynamically produce different color intensities. Most preferably, the appropriate driving waveform is dynamically selected from the plurality of driving waveforms in accordance with the waveform selection algorithm, to enhance different color intensities.

As is known in the art, a ballast can be used to adjust the brightness and the color performance of the color image. A lamp driver may also be used to drive the light bulb base on a certain driving waveform, such as those disclosed in U.S. Patent Publication No. US2009/0251667 A1, which is herein incorporated by reference in its entirety.

In further preferred embodiments, the projection system has a housing 110, and within the housing 110 is disposed a color wheel 104, a light source 102 such as a lamp, and a processor. The projection system 100 further includes a memory in communication with said processor. Within the memory is stored a program of instructions, or logic. The program of instructions enables the system 100 to perform an image data analysis on the inputted image data.

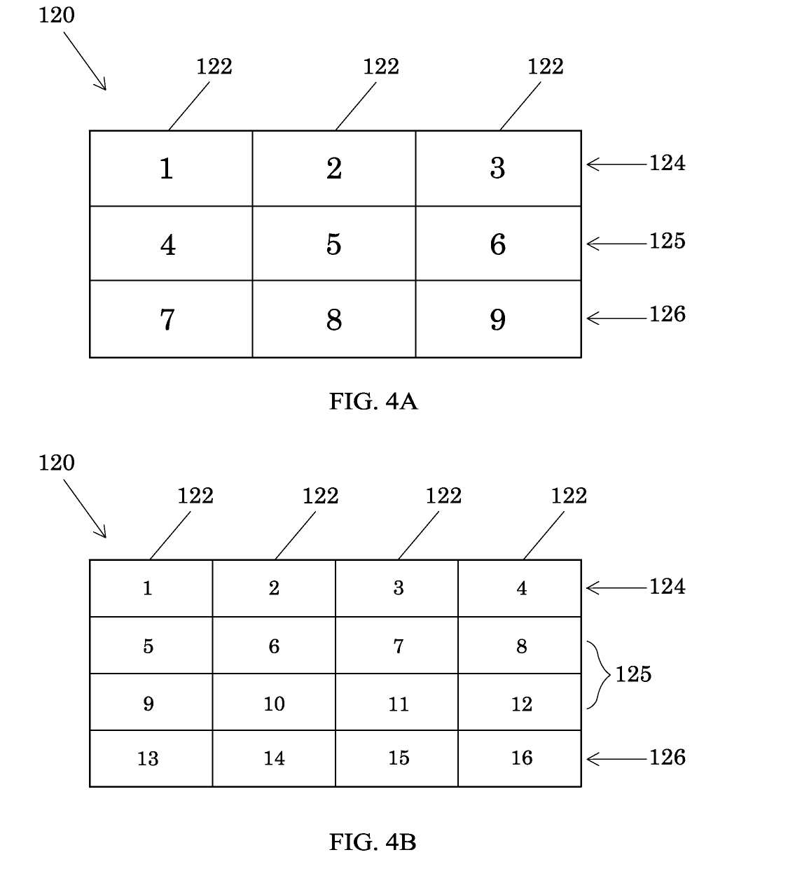

In operation, at least a single frame of the image data is first analyzed. The analysis includes detecting RGB level of the image data by an ADC (analog-to-digital) decoder 112 located within the housing 110. Further, each image frame is detected in a detection window, and the detection window is divided into a plurality of detection regions as defined by a grid as shown in FIGS. 4A and 4B. FIG. 4A shows a detection window 120 having nine detection regions as defined by a grid. FIG. 4B shows a detection window 120 having 16 detection regions as defined by a grid.

In this way, each of said plurality of detection regions 122 can be analyzed to obtain the RGB level of each region 122. Such data is collected and recorded. For example, when the input image is composed of D-sub interface VGA signals, the front-end ADC decoder will perform analog to digital conversion of the three signal sources (i.e., RGB—red, green and blue). In the conversion process, maximum and minimum values of the RGB signals are detected in every single frame. Then, the input frame is divided into nine regions by a signal detection window, so that RGB detection level is recorded as ((Rₘₐₓ, Gₘₐₓ, Bₘₐₓ)_{1˜9} and (Rₘᵢₙ, Gₘᵢₙ, Bₘᵢₙ)_{1˜9}. By associating these parameters with waveform selection algorithm 160, the matching waveform of the image content is calculated.

In the embodiment shown in FIG. 4A, the detection window is divided into nine regions, so that RGB detection level is collected and recorded as (Rₘₐₓ, Gₘₐₓ, Bₘₐₓ)_{1˜9} and (Rₘᵢₙ, Gₘᵢₙ, Bₘᵢₙ)_{1˜9}.

As those of ordinary skill in the art will recognize, the number of detection regions 122 in the detection window 120 may readily be modified (decreased or increased) as dictated by the need for increased degrees of specificity and enhancement. For example, in the embodiment shown in FIG. 4B, the detection window is divided into 16 regions, so that RGB detection level is collected and recorded as (Rₘₐₓ, Gₘₐₓ, Bₘₐₓ)_{1˜16} and (Rₘᵢₙ, Gₘᵢₙ, Bₘᵢₙ)_{1˜16}.

The contemplated program of instructions 150 also enables or performs histogram calculation by using a scaler 114 disposed within said housing 110.

The contemplated scaler 114 modifies the RGB ratio of the image data. Scaler 114 can perform the functions of image processing and data calculation, such as calculating an image histogram. An image histogram is a type of histogram that acts as a graphical representation of the tonal distribution in an image. The histogram plots the number of pixels for each tonal value. The calculated histogram for a specific image provides an overview of the entire tonal distribution of the image.

Preferably, scaler 114 can calculate grayscale histogram distribution to represent the distribution of the signal brightness, as H_{0˜255}(Y). Most preferably, scaler 114 can analyze the brightness distribution of RGB signals, as H_{0˜255}(R), H_{0˜255}(G), H_{0˜255}(B).

After the results are obtained from both the RBG analysis and from the histogram calculation, a waveform selection algorithm 160 is used to find matching waveform curves. Preferably, waveform selection algorithm 160 can be stored in memory 140 and is enabled by the program of instructions 150. As will be described in more details later, in some embodiments of the inventive subject matter, the program of instructions 150 directs the application of the waveform selection algorithm 160 to the results obtained from both the RBG analysis and from the histogram calculation. Preferably, an appropriate waveform index is found based on the RBG level and the histogram.

Contemplated projection system has a waveform data table 170 stored in the memory 140, containing a selection of waveforms to optimize the color vividness level of the projector's visual output. This data table 170 can include the following:
1) increase a pulse waveform in a white region for images with a majority of white color;
2) evenly distribute a waveform in all regions for color still images, and for general briefing images;
3) evenly distribute a waveform in RGB regions with a decrease in white region waveform, for video images;
4) a. increase red and yellow region waveforms, for still images with a majority of warm colors;
   b. increase cyan and green region waveforms, for still images with a majority of green color; and
   c. increase blue region waveform, for still images with a majority of cool color.

As is known in the art, warms colors refer the colors red, orange, and yellow. Cool colors refer to the colors blue, green, and violet.

The selection process can be illustrated as follows: when the algorithm 160 is applied to RGB levels and histogram distribution, the algorithm will implement index 1 waveform above, to increase a pulse waveform in a white region, when RGB levels and histogram are detected to be high for both. High values in both correlates with an image having white color in the majority. In effect, the light source 102 works with the color wheel 104 to focus on the white color output, producing an enhanced vivid image in white regions.

If RGB levels distribute evenly and do not vary significantly with time, index 2 waveform is selected, so that the light source 102 and the color wheel 104 evenly distribute a waveform in all regions. An image having RGB levels that distribute evenly and do not vary significantly with time typically correlates with color still images, and general briefing images.

If low RGB levels is detected in the upper regions 124 and bottom regions 126 of detection window 120, in conjunction with time-varying RGB levels in the middle regions 125, algorithm 160 will select index 3 waveform. This pattern typically correlates with a video image. In effect, the light source 102 works with the color wheel 104 to evenly focus on red, green, and blue regions, and decrease brightness in white regions, to produce an enhanced vivid video image.

If detected RGB levels have a fixed pattern of color (i.e., still images), algorithm 160 will select index 4a, 4b, or 4c waveform, to enhance certain color groups.

In a preferred embodiment, for waveform indexes 1-4, the word “majority,” or “mainly,” is defined as more than 51%; more preferably, >70%; even more preferably, >85%; and most preferably, >90%.

As the projector switches from one waveform to another waveform, image flickering can be undesirable, especially in video images. Therefore, it is further contemplated that such flickering can be reduced by using software to control the switching.

The contemplated inventive subject matter also includes methods of enhancing optical colors in a visual output of a projection system, wherein the visual output includes still images and video images.

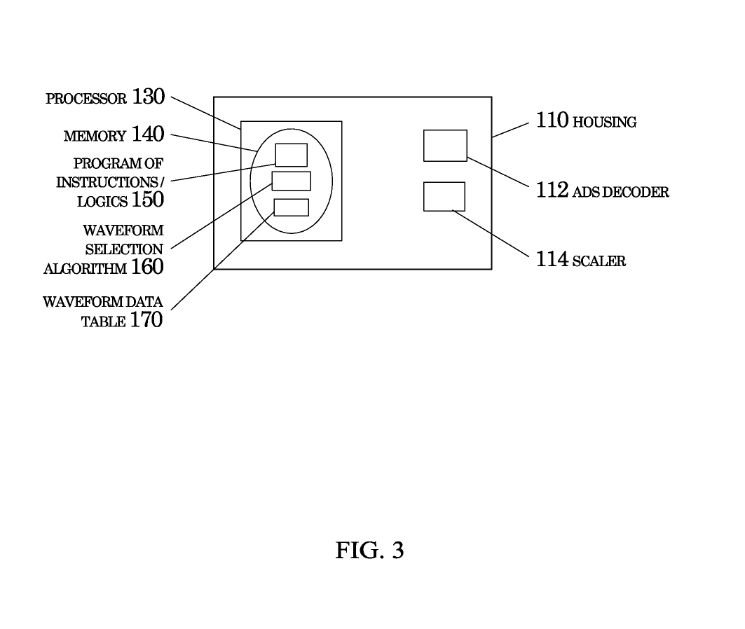

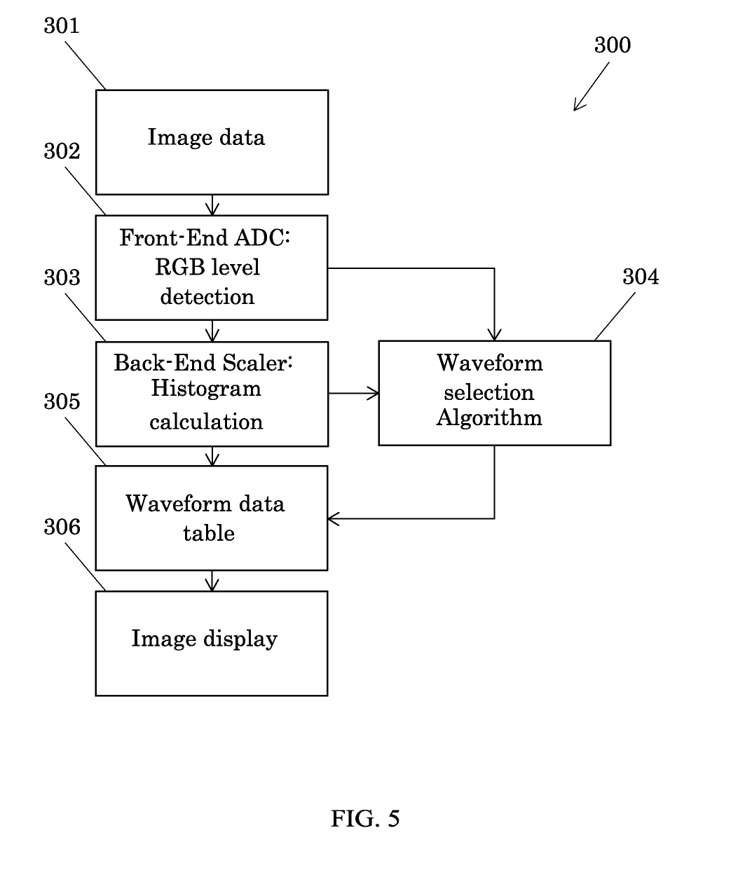

Referring now to FIGS. 3 and 5, in some preferred embodiments, the method includes the steps of having a projection system with a color wheel and a lamp; inputting an image data 301; having a logic to perform a dynamic mode; performing content analysis 302 of the image data; and selecting a dynamic waveform 304.

As contemplated, a dynamic mode dynamically adjusts a waveform to enhance a color vividness base on the content type of the image data. Again, the preferred method applies to still images and video images.

With respect to the step of performing content analysis 302, the contemplated method includes passing a video graphics array (VGA) signal through an analog to digital (ADC) decoder 112 to detect a RGB (red, green, blue) level of at least a single frame of the image data. As such, least a single frame of image data is analyzed in a detection window 120 (see FIGS. 4A and 4B), and wherein the detection window has a grid to define a plurality of detection regions, and wherein each of said plurality of detection regions is analyzed to obtain the RGB level of each detection region, as discussed above.

Additionally, the preferred embodiment further includes the step of calculating a histogram of the image data using a scaler 114 (step 303).

Additionally, it should be appreciated that the method of deriving RGB level data and histogram contemplated herein may be derivatized in numerous manners, and by using other known or yet to be known devices and methods. Also, although no method of interpreting histogram is specifically discussed here, methods of interpreting histogram are known in the art.

Next, the method includes the step of selecting a matching waveform index of the image data (steps 304 and 305) by comparing a first value derived from content analysis to a second value derived from histogram, using a waveform selection algorithm 160. Additionally, the method includes the step of selecting a corresponding waveform from a waveform data table 170 to enhance the color vividness of the visual output.

Most preferably, the logics 150 stored in the memory 140 directs the process of selecting a matching waveform index of the image data by comparing the first value and the second value, using a waveform selection algorithm 160 stored in the memory 140. The logics 150 also enables the selecting of a corresponding waveform from the waveform data table 170.

Thus, specific embodiments and applications of method and apparatus of projector color enhancement by dynamic lamp waveform have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A projection system of color visual output, the system comprising:
a housing;
a color wheel disposed within said housing;
a light source disposed within said housing;
a processor disposed within said housing;
a memory in communication with said processor;
a program of instructions stored within said memory to perform image data analysis, wherein the analysis includes RGB level detection in a single frame of an image data;
the program of instructions also performs histogram calculation; and
a waveform selection algorithm stored within said memory to dynamically and selectively apply a waveform to the light source in order to enhance a selected color.

2. The projection system of claim 1 further comprising an ADC (analog-to-digital) decoder and a scaler disposed within said housing, wherein the program of instructions directs the ADC decoder to perform said image data analysis, and wherein the program of instructions directs the scaler to perform said histogram calculation.

3. The projection system of claim 2 further comprises a waveform data table stored in the memory, containing a selection of waveforms to optimize a color vividness of the visual output, and wherein said selection includes at least one of:
a. increase a waveform in a white region for images with a majority of white color;
b. evenly distribute a waveform in all regions for color still images;
c. evenly distribute a waveform in RGB regions and decrease white region waveform for video images;
d. increase red and yellow region waveforms for images with a majority of warm color;
e. increase cyan and green region waveforms for images with a majority of green color; and
f. increase blue region waveform for images with a majority of cool color.

4. The projection system of claim 3, wherein the program of instruction applies the waveform selection algorithm to a first value of the image data analysis, and to a second value of the histogram calculation, before selecting at least one of said waveform from said selection of waveforms.

5. The projection system of claim 4 further comprising a software embedded in the processor to reduce a flickering of image when the system changes the waveform.

6. The projection system of claim 2 further comprising a detection window with a plurality of detection regions defined by a grid, such that the image data analysis is separately performed for each detection region of the single frame.

7. A method of enhancing optical color in an visual output of a projection system, said method comprising:
having a projection system with a color wheel and a light source;
inputting an image data;
having a logic to perform a dynamic mode;
performing content analysis of the image data;
selecting a dynamic waveform from a waveform data table;
applying a selected waveform to the light source; and
wherein said visual output is at least one selected from still image and motion images.

8. The method as recited in claim 7, wherein the logic dynamically changes the waveform from the selected waveform to another selected waveform, to enhance a color vividness base on a content type of the image data, and wherein the content type includes still images and motion images.

9. The method as recited in claim 8, wherein the step of performing content analysis includes passing a video graphics array (VGA) signal through an analog to digital (ADC) decoder to detect a RGB (red, green, blue) level of at least a single frame of the image data, wherein said at least a single frame is analyzed in a detection window, and wherein the detection window has a grid to define a plurality of detection regions, and wherein each of said plurality of detection regions is analyzed to obtain the RGB level of each detection region.

10. The method as recited in claim 9 further comprising the step of calculating a histogram of the image data using a scaler.

11. The method as recited in claim 10, wherein the selecting step further comprising the step of utilizing a waveform selection algorithm to a first value derived from content analysis, and to a second value derived from histogram.

12. The method as recited in claim 11 further comprising, increase the waveform in all white regions, when the RGB levels and the histogram calculation are detected to be high for both.

13. The method as recited in claim 11 further comprising, evenly distribute the waveform in all regions, if the RGB levels distribute evenly and do not vary significantly over time.

14. The method as recited in claim 11 further comprising, evenly focus the waveform on red, green, and blue regions, and decrease brightness in white regions, if low RGB levels is detected in a upper region and in a bottom region of the detection window is detected in conjunction with time-varying RGB levels in a middle region of the detection window.

15. The method as recited in claim 11 further comprising, focus waveform in red and yellow regions, if detected RGB levels have a fixed pattern of warm colors.

16. A projection system of color visual output, the system comprising:
a housing;
a light emitting element;
a color wheel disposed within the said housing;
a processor disposed within said housing;
a memory in communication with said processor;
a program of instructions stored within said memory to perform image data analysis,
a waveform selection algorithm stored within said memory.
wherein the said light emitting element is controlled by a plurality of driving waveforms to dynamically produce different color intensities;
wherein said driving waveform is dynamically selected from the plurality of driving waveforms to enhance different color intensities.

17. The projection system of claim 16, where the said driving waveform is dynamically selected in accordance with the said waveform selection algorithm.

18. An output color adjusting method applied in a projection system, comprising:
providing a plurality of driving waveforms to a light emitting element in a projector system;
generating different color intensities by dynamically choosing various driving waveforms from said plurality of driving waveforms to adjust different color intensities automatically; and
producing color enhancement base on different displaying contents by the projection system.

19. The method as recited in claim 18 further comprising, performing image data analysis, wherein the analysis includes RGB level detections in a plurality of detection areas in a single frame of an image data.

20. The method as recited in claim 18 further comprising, performing histogram calculations, wherein a RGB level detection by the histogram calculation is performed in a single frame of an image data.
